(19) United States
(12) Patent Application Publication
(10) Pub. No.: US 2025/0094725 A1
(43) Pub. Date: Mar. 20, 2025

(54) DIGITAL ASSISTANT USING GENERATIVE ARTIFICIAL INTELLIGENCE

(71) Applicant: Oracle International Corporation, Redwood Shores, CA (US)

(72) Inventors: Vishal Vishnoi, Redwood City, CA (US); Xin Xu, San Jose, CA (US); Diego Andres Cornejo Barra, Chicago, IL (US); Ying Xu, Albion (AU); Yakupitiyage Don Thanuja Samodhve Dharmasiri, Melbourne (AU); Aashna Devang Kanuga, Foster City, CA (US); Srinivasa Phani Kumar Gadde, Fremont, CA (US); Thanh Long Duong, Melbourne (AU); Mark Edward Johnson, Sydney (AU)

(73) Assignee: Oracle International Corporation, Redwood Shores, CA (US)

(21) Appl. No.: 18/624,472

(22) Filed: Apr. 2, 2024

Related U.S. Application Data
(60) Provisional application No. 63/583,225, filed on Sep. 15, 2023.

(51) Int. Cl. G06F 40/35; G06F 16/332

(52) U.S. Cl. CPC G06F 40/35; G06F 16/3329

(57) ABSTRACT

Techniques are disclosed herein for implementing digital assistants using generative artificial intelligence. An input prompt comprising a natural language utterance and candidate agents and associated actions can be constructed. An execution plan can be generated using a first generative artificial model based on the input prompt. The execution plan can be executed to perform actions included in the execution plan using agents indicated by the execution plan. A response to the natural language utterance can be generated by a second generative artificial intelligence model using one or more outputs from executing the execution plan.

### CROSS-REFERENCE TO RELATED APPLICATION

The present application is a non-provisional application of and claims the benefit and priority under 35 U.S.C. 119(e) of U.S. Provisional Application No. 63/583,225, filed on Sep. 15, 2023, the disclosure of which is incorporated herein by reference in its entirety for all purposes.

### FIELD

The present disclosure relates generally to digital assistants, and more particularly, to techniques for implementing digital assistants using generative artificial intelligence techniques such as those involving large language models.

### BACKGROUND

Artificial intelligence (AI) has diverse applications, with a notable evolution in the realm of digital assistants or chatbots. Originally, many users sought instant reactions through instant messaging or chat platforms. Organizations, recognizing the potential for engagement, utilized these platforms to interact with entities, such as end users, in real-time conversations.

However, maintaining a live communication channel with entities through human service personnel proved to be costly for organizations. In response to this challenge, digital assistants or chatbots, also known as bots, emerged as a solution to simulate conversations with entities, particularly over the Internet. The bots enabled entities to engage with users through messaging apps they already used or other applications with messaging capabilities.

Initially, traditional chatbots relied on predefined skill or intent models, which required entities to communicate within a fixed set of keywords or commands. Unfortunately, this approach limited an ability of the bot to engage intelligently and contextually in live conversations, hindering its capacity for natural communication. Entities were constrained by having to use specific commands that the bot could understand, often leading to difficulties in conveying intention effectively.

The landscape has since transformed with the integration of Large Language Models (LLMs) into digital assistants or chatbots. LLMs are deep learning algorithms that can perform a variety of natural language processing (NLP) tasks. They use a neural network architecture called a transformer, which can learn from the patterns and structures of natural language and conduct more nuanced and contextually aware conversations for various domains and purposes. This evolution marks a significant shift from rigid keyword-based interactions to a more adaptive and intuitive communication experience compared to traditional chatbots, enhancing the overall capabilities of digital assistants or chatbots in understanding and responding to user queries.

### BRIEF SUMMARY

In various embodiments, a computer-implemented method is provided that can be used to implement digital assistants using generative artificial intelligence. The computer-implemented method can include constructing an input prompt including a natural language utterance received from a user. The computer-implemented method can include generating, by a first generative artificial intelligence model using the input prompt, an execution plan for executing one or more requests represented by the natural language utterance. Generating the execution plan can include determining, based on the one or more potential agents and associated actions, one or more agents and one or more actions associated with the one or more agents that can service the one or more requests. Generating the execution plan can additionally include generating a structured output for the execution plan by creating an ordered list that includes one or more actions for executing the one or more requests. The computer-implemented method can include executing the execution plan to perform the one or more actions using one or more agents. Executing the execution plan can include (i) triggering performance of the one or more actions by the one or more agents, and (ii) receiving one or more outputs from performance of the one or more actions by the one or more agents. The computer-implemented method can include generating, by a second generative artificial intelligence model using the one or more outputs, a response to the natural language utterance.

In certain embodiments, constructing the input prompt can include (i) executing, using the natural language utterance, a semantic search on descriptions associated with the available agents and actions in a data store, (ii) identifying, based on a semantic search, the one or more candidate agents and associated actions, and (iii) constructing a natural language representation for the input prompt by appending the one or more candidate agents and associated actions to the natural language utterance.

In certain embodiments, the natural language utterance can be a continuation or subsequent utterance within a conversation. Additionally, the input prompt can additionally include (iii) conversation history and actions executed prior to the natural language utterance. Additionally, constructing the input prompt can include accessing the conversation history and the actions executed prior to the natural language utterance, and constructing the natural language representation for the input prompt by appending the one or more candidate agents, the associated actions, and the conversation history and the actions executed prior to the natural language utterance to the natural language utterance.

In certain embodiments, the one or more agents can be a set of agents and the one or more actions are a set of actions. Additionally, a first subset of the set of agents and the set of actions are in a first state, and a second subset of the set of agents and the set of actions are in a second state. Additionally, the first state can be a ready-for-execution state. Additionally, the second state can be a not-ready-for-execution state in which additional information is required prior to execution of one or more actions within the second subset of the set of agents and the set of actions.

In certain embodiments, executing the execution plan can include accessing contextual information that is needed by at least one of the one or more agents for performing at least one of the one or more actions. Additionally, triggering the performance of the one or more actions can include forwarding one or more requests for performance of the one or more actions to the one the one or more agents. Additionally, a request of the one or more requests being forwarded for performance of the at least one of the one or more actions can include the contextual information.

In certain embodiments, the one or more agents are a set of agents, the one or more actions are a set of actions, and the one or more requests are a set of requests. Additionally, generating the execution plan can include determining whether one or more dependencies exist between the set of actions, and when the one or more dependencies exist, the ordered list can be created to include the set of agents, the set of actions for executing the one or more requests, and an indication of the one or more dependencies. Additionally, when the execution plan includes the indication of the one or more dependencies, the performance of the one or more actions by the one or more agents can be triggered via serial processing. Additionally, when the execution plan does not include the indication of the one or more dependencies, the performance of the one or more actions by the one or more agents can be triggered via parallel processing. Additionally, the response can be an aggregate response including a set of responses to the set of requests within the natural language utterance.

In certain embodiments, the natural language utterance can be a continuation or subsequent utterance within a conversation. Additionally, the response to the natural language utterance can be generated by the second generative artificial intelligence model using the one or more outputs, the natural language utterance, and a conversation history for the conversation.

In certain embodiments, the computer-implemented method additionally includes communicating the response to the user.

In certain embodiments, the first generative artificial intelligence model can be the same model as the second generative artificial intelligence model.

In various embodiments, a system is provided and can be used to implement digital assistants using generative artificial intelligence. The system can include one or more processors and one or more computer-readable media storing instructions which, when executed by the one or more processors, can cause the system to perform part or all of the operations and/or methods disclosed herein.

In various embodiments, one or more non-transitory computer-readable media are provided and can be used to implement digital assistants using generative artificial intelligence. The one or more non-transitory computer-readable media can store instructions which, when executed by one or more processors, can cause a system to perform part or all of the operations and/or methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is a simplified block diagram of a distributed environment incorporating a digital assistant system in accordance with various embodiments.

FIG. 2 is an example of a user interface for configuring an agent of a digital assistant in accordance with various embodiments.

FIG. 3 is an example of a computing environment involving a digital assistant that can be implemented with generative artificial intelligence in accordance with various embodiments.

FIG. 4 is a flowchart of a process for generating a response to user input using a digital assistant that can be implemented using generative artificial intelligence in according with various embodiments.

FIG. 5 depicts a simplified diagram of a distributed system for implementing various embodiments.

FIG. 6 is a simplified block diagram of one or more components of a system environment by which services provided by one or more components of an embodiment system may be offered as cloud services, in accordance with various embodiments.

FIG. 7 illustrates an example computer system that may be used to implement various embodiments.

### DETAILED DESCRIPTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

### INTRODUCTION

Artificial intelligence techniques have broad applicability. For example, a digital assistant can be or include an artificial-intelligence-driven interface that helps users accomplish a variety of tasks using natural language conversations. For conventional digital assistants, such as those that do not involve generative artificial intelligence, a provider of the digital assistant may assemble one or more skills that can be focused on specific types of tasks such as tracking inventory, submitting timecards, and creating expense reports. When an end user engages with the digital assistant, the digital assistant can evaluate input provided by the end user to determine the intent of the end user and can route the conversation to and from the appropriate skill based on a perceived intent of the end user. However, there are some disadvantages of traditional intent-based skills including a limited understanding of natural language, inability to handle unknown inputs, limited ability to hold natural conversations off script, challenges integrating external knowledge, and the like.

User interactions with a digital assistant can lead to prompt responses to queries or the execution of requested actions. Additionally, these interactions have the potential to emulate human-like conversations, resembling a natural back-and-forth dialogue between a user and a human operator. To enhance user experience, digital assistants may also engage in multimodal communications, allowing users to convey information through spoken utterances or alternative input methods, such as selecting options on a computer display. However, achieving such functionalities efficiently with digital assistants, especially through natural language models, poses several challenges. For instance, understanding human speech remains a significant hurdle for natural language models, even those based on machine-learning. The scalability of the models can be problematic and inefficient, while their domain-specific limitations further complicate effective communication in various contexts.

The advent of generative artificial intelligence techniques and models, such as large language models (LLMs), has propelled the field of digital assistant design to unprecedented levels of sophistication and can be used to address the above and other technical problems associated with traditional intent-based skills. An LLM can be or include a neural network that employs a transformer architecture, which is specifically generated for processing and generating sequential data such as text or words in conversations. LLMs can undergo training with extensive textual data, and the training can gradually hone an ability to generate text that closely mimics human-written or spoken language. While LLMs excel at predicting the next word in a sequence, it's important to note that their output isn't guaranteed to be entirely accurate. Their text generation relies on learned patterns and information from training data, which could be incomplete, erroneous, or outdated, as their knowledge is confined to their training dataset. LLMs don't possess the capability to recall facts from memory; instead, the focus of the LLM is on generating text that appears contextually appropriate.

To address this limitation and others, techniques are described herein to enhance LLMs with tools that empower or otherwise provide the LLMs access to external knowledge sources that provide the LLMs with the capability to recall facts and/or knowledge and facilitate the LLMs to better understand and respond to user queries in a contextually relevant manner. These tools, referred to herein as “agents,” provide the capability to recall facts and/or knowledge utilizing various techniques such as knowledge graphs, custom knowledge bases, Application Programming Interfaces (APIs), web crawling or scraping, and the like. In some examples, the tools, or the agents, can be powered or otherwise controlled by the LLMs. Once configured, the LLMs and agents can be deployed in artificial intelligence-based systems such as digital assistant applications. Users, such as end users or other entities, can interact with the digital assistant, such as by posing questions or making requests, and the LLMs and agents can work in tandem to generate responses based on a combination of a base LLM capability and access to the external knowledge via the agent. Using the LLMs and agents allows the digital assistant to provide more accurate, relevant, and contextually appropriate responses across a wide range of applications and domains.

For each digital assistant, a user (e.g., developer) may assemble LLMs and agents that interact to provide human-like conversation capabilities for various types of tasks such as tracking inventory, submitting timecards, updating accounts, creating expense reports, and the like. The LLMs are machine learning models trained on for various tasks including plan creation using the LLM's in-context learning capability, knowledge or information retrieval on behalf of an agent, response generation to facilitate the human-like conversation, or any combination thereof. The agents are essentially containers having a software package containing everything needed to execute one or more actions defined for the agents. For example, the software package may include the code and any runtime configurations the code requires, application and system libraries, default values for any settings, and the like. The configuration parameters, settings, and customizations for dialog and routing/reasoning are primarily defined using natural language by a user (e.g., a developer). For example, users can provide configuration parameters that connect the agent to external assets, such as APIs, knowledge-based assets such as documents, URLs, LLMs, images, etc., data stores, prior conversations, etc. for executing one or more actions (e.g., change a user's 401k contribution). Once an agent is created, flow confirmation and testing may be performed through simulated conversations with LLMs and agents, and a digital assistant can then be implemented.

Implementation of an LLM-based digital assistant generally involves receiving a user input, such as a verbal request, command, or other statement (e.g., an utterance) from which the LLM digital assistant has a high-level awareness of the goal of the end user. A list of candidate agents is then determined based on the user input. The list of candidate agents includes agents configured to perform one or more actions that may potentially facilitate a response to the user input. Metadata for the agents in the list of candidate agents is then combined with the user input to construct an input prompt for an LLM. The LLM generates an execution plan that includes actions for facilitating a response to the user input based on the input prompt and metadata. The execution plan is then executed by an execution engine, which causes the agents to execute the actions. The actions may include internal task mapping in which a given action can be mapped to an API or semantic search knowledge task type. The execution of the actions generates output data from various sources, such as knowledge, API, SQL operations, etc., and/or relevant context and memory information from a context and memory store. The output data and relevant context and memory information are then combined with the user input to construct an output prompt for an LLM. The LLM synthesizes a response to the user input based on the output data and relevant context and memory information, and user input. The response is then sent to the user as an individual response or as part of a conversation with the user.

In one particular aspect, a computer-implemented method is provided that comprises: constructing an input prompt comprising a natural language utterance received from a user, generating, by a first generative artificial intelligence model using the input prompt, an execution plan for executing one or more requests represented by the natural language utterance, wherein generating the execution plan comprises: determining, based on the one or more candidate agents and associated actions, one or more agents and one or more actions associated with the one or more agents that can service the one or more requests, and generating a structured output for the execution plan by creating an ordered list that comprises one or more actions for executing the one or more requests, executing the execution plan to perform the one or more actions using one or more agents, wherein executing the execution plan comprises: triggering performance of the one or more actions by the one or more agents, and receiving one or more outputs from performance of the one or more actions by the one or more agents; and generating, by a second generative artificial intelligence model using the one or more outputs, a response to the natural language utterance.

Advantageously, the LLM-based digital assistant described herein leverages reasoning capabilities of LLMs to drive decision-making and action orchestration to recall facts and/or knowledge and to facilitate the LLMs to better understand and respond to user queries in a contextually relevant manner. Additionally or alternatively, the LLM-based digital assistant can eliminate a need for scripted dialog flows and provide out-of-the-box, human-like conversation capabilities.

As used herein, when an action is “based on” something, this means the action can be based at least in part on at least a part of the something. As used herein, the terms “similarly,” “substantially,” “approximately,” and “about” are defined as being largely but not necessarily wholly what is specified (and include wholly what is specified) as understood by one of ordinary skill in the art. In any disclosed embodiment, the term “similarly,” “substantially,” “approximately,” or “about” may be substituted with “within [a percentage] of” what is specified, where the percentage includes 0.1 percent, 1 percent, 5 percent, and 10 percent, etc.

### LLM-Based Digital Assistant

A digital assistant can be or include a computer program that can perform conversations with end users. The digital assistant can generally respond to natural-language messages, such as questions and/or comments, through a messaging application (referred to herein as channels) that uses natural-language messages. The digital assistant can be made available to end users through a variety of channels, as well as via an application interface that may be developed to include a digital assistant, for example using a digital assistant software development kit. The channels may be or include an end-user-preferred messaging application that the end user has already installed and with which the end user may already be familiar. In some examples, the end user may not need to download and install new applications in order to converse with the digital assistant system. The channels may include, for example, over-the-top (OTT) messaging channels, such as Facebook™ Messenger, Facebook™ WhatsApp™, WeChat™, Line, Kik™, Telegram™, Talk, Skype™, Slack™, or SMS), virtual private assistants (such as Amazon™ Dot, Echo, or Show, Google™ Home, Apple™ HomePod™, etc.), mobile and web app extensions that extend native or hybrid/responsive mobile apps or web applications with chat capabilities, or voice based input such as devices or apps with interfaces that use Siri™, Cortana™, Google™ Voice, or other speech input for interaction.

The channels can carry the chat back and forth from end users to the digital assistant and various LLMs associated with the digital assistant. During the back-and-forth exchanges, the LLMs can receive the processed input in the form of a query and can process the query to generate a response. An LLM can predict the most contextually relevant and grammatically correct response based on training data used to train the LLM and based on received input such as the query and actions executed by the agents. The generated response may undergo post-processing to ensure adherence to guidelines, policies, and formatting standards associated with the digital assistant. This post-processed response may be more coherent and user-friendly than other responses that do not undergo post-processing. The post-processed response can be delivered to the user through the appropriate channel, which may be or include a text-based chat interface, a voice-based system, or another medium. According to various embodiments, the digital assistant can maintain the conversation context, allowing for further interactions and dynamic back-and-forth exchanges between the user and the LLMs where later interactions can build upon earlier interactions.

In some embodiments, the digital assistant system may intelligently handle end user interactions without interaction with a provider, such as an administrator or developer, of the digital assistant system. For example, an end user may send one or more messages to the digital assistant system in order to achieve a desired goal. A message may include certain content, such as text, emojis, audio, image, video, or other method of conveying a message. In some embodiments, the digital assistant system may convert the content into a standardized form, such as a representational state transfer (REST) or API call, against enterprise services with the proper parameters, and generate a natural language response. The digital assistant system may also prompt the end user for additional input parameters or request other additional information. In some embodiments, the digital assistant system may also initiate communication with the end user, rather than passively responding to end user utterances. Various techniques can be used for identifying an explicit invocation of a digital assistant system and determining an input for the digital assistant system being invoked. In certain embodiments, explicit invocation analysis can be performed by a master digital assistant based at least in part on detecting an invocation name in an utterance. In response to detecting the invocation name, the utterance may be refined or pre-processed for input to a digital assistant that is identified to be associated with the invocation name and/or communication.

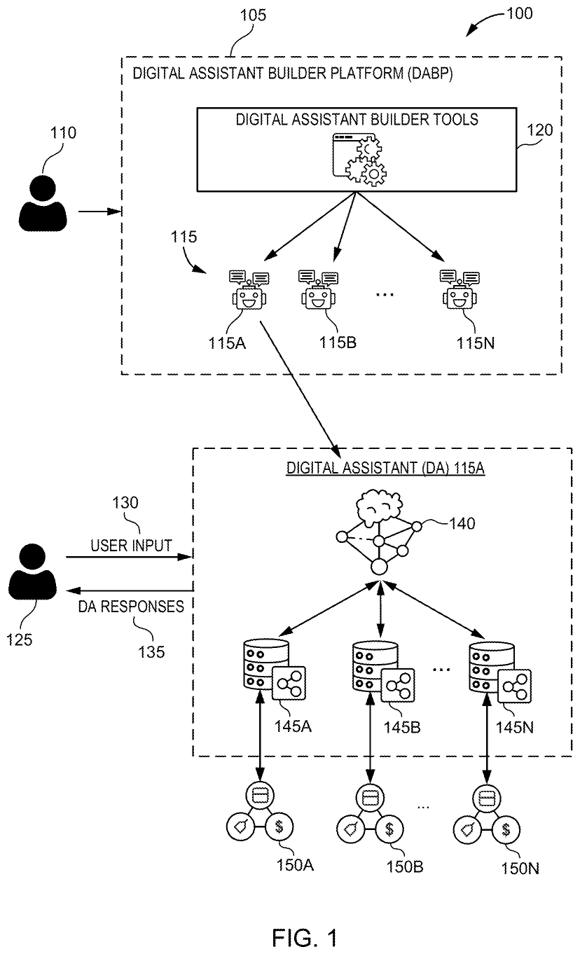

FIG. 1 is a simplified block diagram of an environment 100 incorporating a digital assistant system according to certain embodiments. Environment 100 includes a digital assistant builder platform (DABP) 105 that enables users 110 to create and deploy digital assistant systems 115. For purposes of this disclosure, a “digital assistant” is an entity that helps users of the digital assistant accomplish various tasks through natural language conversations. A digital assistant can be implemented using software only (e.g., the digital assistant is a digital entity implemented using programs, code, or instructions executable by one or more processors), using hardware, or using a combination of hardware and software. A digital assistant can be embodied or implemented in various physical systems or devices, such as in a computer, a mobile phone, a watch, an appliance, a vehicle, and the like. A digital assistant is also sometimes referred to as a chatbot system. Accordingly, for purposes of this disclosure, the terms digital assistant and chatbot system are interchangeable.

DABP 105 can be used to create one or more digital assistants (or DAs) systems. For example, as illustrated in FIG. 1, user 110 representing a particular enterprise can use DABP 105 to create and deploy a digital assistant 115A for users of the particular enterprise. For example, DABP 105 can be used by a bank to create one or more digital assistants for use by the bank's customers, for example to change a 401k contribution, etc. The same DABP 105 platform can be used by multiple enterprises to create digital assistants. As another example, an owner of a restaurant, such as a pizza shop, may use DABP 105 to create and deploy digital assistant 115B that enables customers of the restaurant to order food (e.g., order pizza).

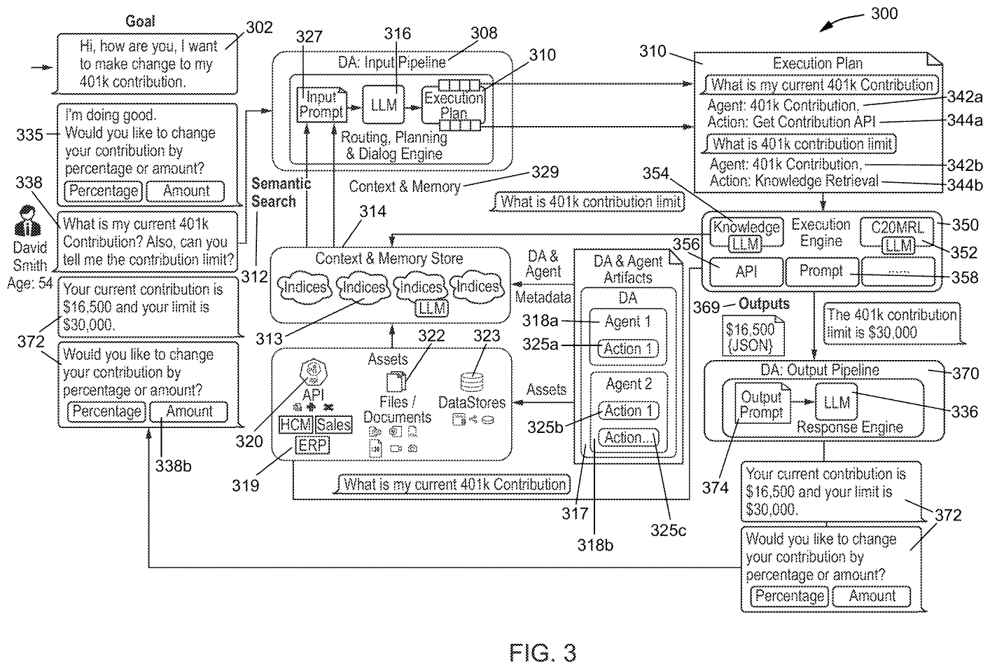

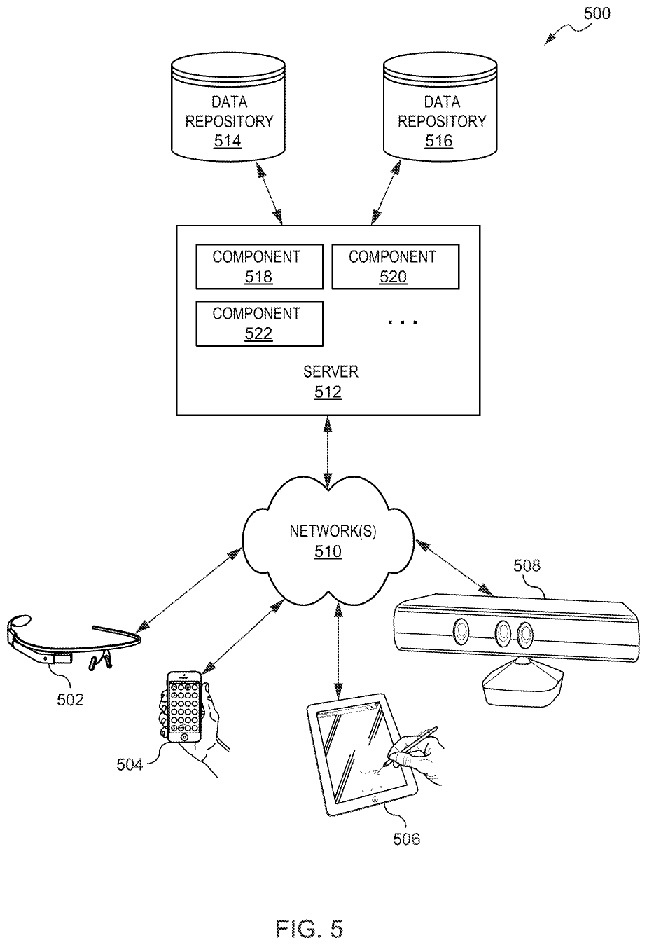

To create one or more digital assistant systems 115, the DABP 105 is equipped with a suite of tools 120, enabling the acquisition of LLMs, agent creation, asset identification, and deployment of digital assistant systems within a service architecture (described herein in detail with respect to FIG. 3) for users via a computing platform such as a cloud computing platform described in detail with respect to FIGS. 5-8. In some instances, the tools 120 can be utilized to access pre-trained and/or fine-tuned LLMs from data repositories or computing systems. The pre-trained LLMs serve as foundational elements, possessing extensive language understanding derived from vast datasets. This capability enables the models to generate coherent responses across various topics, facilitating transfer learning. Pre-trained models offer cost-effectiveness and flexibility, which allows for scalable improvements and continuous pre-training with new data, often establishing benchmarks in Natural Language Processing (NLP) tasks. Conversely, fine-tuned models are specifically trained for tasks or industries (e.g., plan creation utilizing the LLM's in-context learning capability, knowledge or information retrieval on behalf of an agent, response generation for human-like conversation, etc.), enhancing their performance on specific applications and enabling efficient learning from smaller, specialized datasets. Fine-tuning provides advantages such as task specialization, data efficiency, quicker training times, model customization, and resource efficiency. In some embodiments, fine-tuning may be particularly advantageous for niche applications and ongoing enhancement.

In other instances, the tools 120 can be utilized to pre-train and/or fine-tune the LLMs. The tools 120, or any subset thereof, may be standalone or part of a machine-learning operationalization framework, inclusive of hardware components like processors (e.g., CPU, GPU, TPU, FPGA, or any combination), memory, and storage. This framework operates software or computer program instructions (e.g., TensorFlow, PyTorch, Keras, etc.) to execute arithmetic, logic, input/output commands for training, validating, and deploying machine-learning models in a production environment. In certain instances, the tools 120 implement the training, validating, and deploying of the models using a cloud platform such as Oracle Cloud Infrastructure (OCI). Leveraging a cloud platform can make machine-learning more accessible, flexible, and cost-effective, which can facilitate faster model development and deployment for developers.

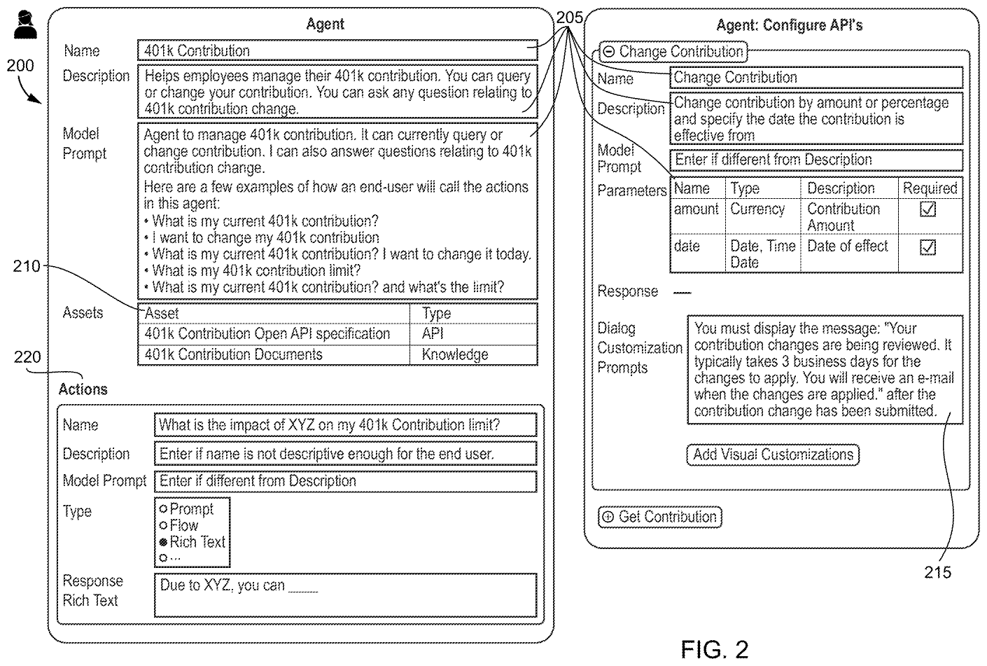

The tools 120 further include a prompt-based agent composition unit for creating agents and their associated actions (e.g., a prompt such as Tell me a joke, implicit Change Contribution, and Get Contribution API calls) that an end-user can end up invoking. As further shown in FIG. 2, the agents (e.g., 401k Change Contribution Agent 200) are primarily defined as a compilation of agent artifacts 205 using natural language within the prompt-based agent composition unit. Users 110 can create functional agents quickly by providing agent artifact 205 information, parameters, and configurations and by pointing to assets 210. The assets 210 are resources such as APIs for interfacing with applications, files and/or documents for retrieving knowledge, data stores for interacting with data, and the like available to the agents for the execution of actions. The assets 210 are imported, and then the users 110 can use natural language again to provide additional API customizations for dialog and routing/reasoning 215. Most of what an agent does involves executing actions 220. An action 220 can be an explicit one that's authored using natural language (similar to creating agent artifacts—e.g., ‘What is the impact of XYZ on my 401k Contribution limit?’ action in the below ‘401k Contribution Agent’ figure) or an implicit one that is created when an asset is imported (automatically imported upon pointing to a given asset based on metadata and/or specifications associated with the asset—e.g., actions created for Change Contribution and Get Contribution API in the below ‘401k Contribution Agent’ figure). In the agent example illustrated in FIG. 2, the design time user can easily create explicit actions. For example, the user chooses the ‘Rich Text’ action type (see Table 1 for a list of exemplary action types) and creates the name artifact ‘What is the impact of XYZ on my 401k Contribution limit?’ when the user learns that a new FAQ needs to be added, as it's not currently in the knowledge documents (assets 210) the agent references (thus was not implicitly added as an action).

TABLE 1

| | Action Type | Description |
|---|---|---|
| 1 | Prompt | The action is implemented using a prompt to an LLM. |
| 2 | Rich Text | The action is implemented using rich text. |
| | | The most common use case is FAQs. |
| 3 | Flow | The action is implemented using Visual Flow Designer |
| | | flow. May be used for complex cases where |
| | | the developer is not able to use the out-of-the-box |
| | | dialogue and dialog customizations. |

There are various ways in which the agents and assets can be associated or added to a digital assistant 115. In some instances, the agents can be developed by an enterprise and then added to a digital assistant using DABP 105. In other instances, the agents can be developed and created using DABP 105 and then added to a digital assistant created using DABP 105. In yet other instances, DABP 105 provides an online digital store (referred to as an “agent store”) that offers various pre-created agents directed to a wide range of tasks and actions. The agents offered through the agent store may also expose various cloud services. In order to add the agents to a digital assistant being generated using DABP 105, a user 110 of DABP 105 can access assets via tools 120, select specific assets for an agent, initiate a few mock chat conversations with the agent, and indicate that the agent is to be added to the digital assistant created using DABP 105.

Once deployed in a production environment, such as the architecture described with respect to FIG. 3, a digital assistant, such as digital assistant 115A built using DABP 105, can be used to perform various tasks via natural language-based conversations between the digital assistant 115A and its users 125. As described above, the digital assistant 115A illustrated in FIG. 1, can be made available or accessible to its users 125 through a variety of different channels, such as but not limited to, via certain applications, via social media platforms, via various messaging services and applications, and other applications or channels. A single digital assistant can have several channels configured for it so that it can be run on and be accessed by different services simultaneously.

As part of a conversation, a user 125 may provide one or more user inputs 130 to digital assistant 115A and get responses 135 back from digital assistant 115A. A conversation can include one or more of user inputs 130 and responses 135. Via these conversations, a user 125 can request one or more tasks to be performed by the digital assistant 115A and, in response, the digital assistant 115A is configured to perform the user-requested tasks and respond with appropriate responses to the user 125 using one or more LLMs 140.

User inputs 130 are generally in a natural language form and are referred to as utterances, which may also be referred to as prompts, queries, requests, and the like. The user inputs 130 can be in text form, such as when a user types in a sentence, a question, a text fragment, or even a single word and provides it as input to digital assistant 115A. In some embodiments, a user input 130 can be in audio input or speech form, such as when a user says or speaks something that is provided as input to digital assistant 115A. The user inputs 130 are typically in a language spoken by the user 125. For example, the user inputs 130 may be in English, or some other language. When a user inputs 130 is in speech form, the speech input is converted to text form user inputs 130 in that particular language and the text utterances are then processed by digital assistant 115A. Various speech-to-text processing techniques may be used to convert a speech or audio input to a text utterance, which is then processed by digital assistant 115A. In some embodiments, the speech-to-text conversion may be done by digital assistant 115A itself. For purposes of this disclosure, it is assumed that the user inputs 130 are text utterances that have been provided directly by a user 125 of digital assistant 115A or are the results of conversion of input speech utterances to text form. This however is not intended to be limiting or restrictive in any manner.

The user inputs 130 can be used by the digital assistant 115A to determine a list of candidate agents 145A-N. The list of candidate agents (e.g., 145A-N) includes agents configured to perform one or more actions that could potentially facilitate a response 135 to the user input 130. The list may be determined by running a search, such as a semantic search, on a context and memory store that has one or more indices comprising metadata for all agents 145 available to the digital assistant 115A. Metadata for the candidate agents 145A-N in the list of candidate agents is then combined with the user input to construct an input prompt for the one or more LLMs 140.

Digital assistant 115A is configured to use one or more LLMs 140 to apply NLP techniques to text and/or speech to understand the input prompt and apply natural language understanding (NLU) including syntactic and semantic analysis of the text and/or speech to determine the meaning of the user inputs 130. Determining the meaning of the utterance may involve identifying the goal of the user, one or more intents of the user, the context surrounding various words or phrases or sentences, one or more entities corresponding to the utterance, and the like. The NLU processing can include parsing the received user inputs 130 to understand the structure and meaning of the utterance, refining and reforming the utterance to develop a better understandable form (e.g., logical form) or structure for the utterance. The NLU processing performed can include various NLP-related processing such as sentence parsing (e.g., tokenizing, lemmatizing, identifying part-of-speech tags for the sentence, identifying named entities in the sentence, generating dependency trees to represent the sentence structure, splitting a sentence into clauses, analyzing individual clauses, resolving anaphoras, performing chunking, and the like). In certain instances, the NLU processing, or any portions thereof, is performed by the LLMs 140 themselves. In other instances, the LLMs 140 use other resources to perform portions of the NLU processing. For example, the syntax and structure of an input utterance sentence may be identified by processing the sentence using a parser, a part-of-speech tagger, a named entity recognition model, a pretrained language model such as BERT, or the like.

Upon understanding the meaning of an utterance, the one or more LLMs 140 generate an execution plan that identifies one or more agents (e.g., agent 145A) from the list of candidate agents to execute and perform one or more actions or operations responsive to the understood meaning or goal of the user. The one or more actions or operations are then executed by the digital assistant 115A on one or more assets (e.g., asset 150A—knowledge, API, SQL operations, etc.) and/or the context and memory store. The execution of the one or more actions or operations generates output data from one or more assets and/or relevant context and memory information from a context and memory store comprising context for a present conversation with the digital assistant 115A. The output data and relevant context and memory information are then combined with the user input 130 to construct an output prompt for one or more LLMs 140. The LLMs 140 synthesize the response 135 to the user input 130 based on the output data and relevant context and memory information, and the user input 130. The response 135 is then sent to the user 125 as an individual response or as part of a conversation with the user 125.

For example, a user input 130 may request a pizza to be ordered by providing an utterance such as “I want to order a pizza.” Upon receiving such an utterance, digital assistant 115A is configured to understand the meaning or goal of the utterance and take appropriate actions. The appropriate actions may involve, for example, providing responses 135 to the user with questions requesting user input on the type of pizza the user desires to order, the size of the pizza, any toppings for the pizza, and the like. The questions requesting user may be generated by executing an action via an agent (e.g., agent 145A) on a knowledge asset (e.g., a menu for a pizza restaurant) to retrieve information that is pertinent to ordering a pizza (e.g., to order a pizza a user must provide type, seize, topping, etc.). The responses 135 provided by digital assistant 115A may also be in natural language form and typically in the same language as the user input 130. As part of generating these responses 135, digital assistant 115A may perform natural language generation (NLG) using the one or more LLMs 140. For the user ordering a pizza, via the conversation between the user and digital assistant 115A, the digital assistant 115A may guide the user to provide all the requisite information for the pizza order, and then at the end of the conversation cause the pizza to be ordered. The ordering may be performed by executing an action via an agent (e.g., agent 145A) on an API asset (e.g., an API for ordering pizza) to upload or provide the pizza order to the ordering system of the restaurant. Digital assistant 115A may end the conversation by generating a final response 135 providing information to the user 125 indicating that the pizza has been ordered.

While the various examples provided in this disclosure describe and/or illustrate utterances in the English language, this is meant only as an example. In certain embodiments, digital assistants 115 are also capable of handling utterances in languages other than English. Digital assistants 115 may provide subsystems (e.g., components implementing NLU functionality) that are configured for performing processing for different languages. These subsystems may be implemented as pluggable units that can be called using service calls from an NLU core server. This makes the NLU processing flexible and extensible for each language, including allowing different orders of processing. A language pack may be provided for individual languages, where a language pack can register a list of subsystems that can be served from the NLU core server.

While the embodiment in FIG. 1 illustrates the digital assistant 115A including one or more LLMs 140 and one or more agents 145A-N, this is not intended to be limiting. A digital assistant can include various other components (e.g., other systems and subsystems as described in greater detail with respect to FIG. 3) that provide the functionalities of the digital assistant. The digital assistant 115A and its systems and subsystems may be implemented only in software (e.g., code, instructions stored on a computer-readable medium and executable by one or more processors), in hardware only, or in implementations that use a combination of software and hardware.

FIG. 3 is an example of an architecture for a computing environment 300 for a digital assistant implemented with generative artificial intelligence in accordance with various embodiments. As illustrated in FIG. 3, an infrastructure and various services and features can be used to enable a user to interact with a digital assistant (e.g., digital assistant 115A described with respect to FIG. 1) based at least in part on a series of prompts such as a conversation. The following is a detailed walkthrough of a conversation flow and the role and responsibility of the components, services, models, and the like of the computing environment 300 within the conversation flow. In this walkthrough, it is assumed that a user “David” is interested in making a change to his 401k contribution, and in an utterance 302, David provides the following input to the digital assistant: Hi, how are you, I want to make a change to my 401k contribution.

The utterance 302 can be communicated to the digital assistant (e.g., via text dialogue box or microphone) and provided as input to the input pipeline 308. The input pipeline 308 is used by the digital assistant to create an execution plan 310 that identifies one or more agents to address the request in the utterance 302 and one or more actions for the one or more agents to execute for responding to the request. A two-step approach can be taken via the input pipeline 308 to generate the execution plan 310. First, a search 312 can be performed to identify a list of candidate agents. The search 312 comprises running a query on indices 313 of a context and memory store 314 based on the utterance 302. In some instances, the search 312 is a semantic search performed using words from the utterance 302, The semantic search uses NLP and optionally machine learning techniques to understand the meaning of the utterance 302 and retrieve relevant information from the context and memory store 314. In contrast to traditional keyword-based searches, which rely on exact matches between the words in the query and the data in the context and memory store 314, a semantic search takes into account the relationships between words, the context of the query, synonyms, and other linguistic nuances. This allows the digital assistant to provide more accurate and contextually relevant results, making it more effective in understanding the user's intent in the utterance 302.

The context and memory store 314 is implemented using a data framework for connecting external data to LLMs 316 to make it easy for users to plug in custom data sources. The data framework provides rich and efficient retrieval mechanisms over data from various sources such as files, documents, datastores, APIs, and the like. The data can be external (e.g., enterprise assets) and/or internal (e.g., user preferences, memory, digital assistant, and agent metadata, etc.). In some instances, the data comprises metadata extracted from artifacts 317 associated with the digital assistant and its agents 318 (e.g., 318a and 318b). The artifacts 317 for the digital assistant include information on the general capabilities of the digital assistant and specific information concerning the capabilities of each of the agents 318 (e.g., actions 220 described with respect to FIG. 2) available to the digital assistant (e.g., agent artifacts 205 described with respect to FIG. 2). Additionally or alternatively, the artifacts 317 can encompass parameters or information associated with the artifacts 317 and that can be used to define the agents 318 in which the parameters or information associated with the artifacts 317 can include a name, a description, one or more actions, one or more assets, one or more customizations, etc. In some instances, the data further includes metadata extracted from assets 319 associated with the digital assistant and its agents 318 (e.g., 318a and 318b). The assets 319 may be resources, such as APIs 320, files and/or documents 322, data stores 323, and the like, available to the agents 318 for the execution of actions (e.g., actions 325a, 325b, and 325c). The data is indexed in the context and memory store 314 as indices 313, which are data structures that provide a fast and efficient way to look up and retrieve specific data records within the data. Consequently, the context and memory store 314 provides a searchable comprehensive record of the capabilities of all agents and associated assets that are available to the digital assistant for responding to the request.

The results of the search 312 include a list of candidate agents that are not just available to the digital assistant for responding to the request but also potentially capable of facilitating the generation of a response to the utterance 302. The list of candidate agents includes the metadata (e.g., metadata extracted from artifacts 317 and assets 319) from the context and memory store 314 that is associated with each of the candidate agents. The list can be limited to a predetermined number of candidate agents (e.g., top 10) that satisfy the query or can include all agents that satisfy the query. The list of candidate agents with associated metadata is appended to the utterance 302 to construct an input prompt 327 for the LLM 316. In some instances, context 329 concerning the utterance 302 are additionally appended to the list of candidate agents and the utterance 302. The context 329 is retrievable from the context and memory store 314 and includes user session information, dialog state, conversation or contextual history, user information, or any combination thereof. The search 312 is important to the digital assistant because it filters out agents that are unlikely to be capable of facilitating the generation of a response to the utterance 302. This filter ensures that the number of tokens (e.g., word tokens) generated from the input prompt 327 remains under a maximum token limit or context limit set for the LLM 316. Token limits represent the maximum amount of text that can be inputted into an LLM. This limit is of a technical nature and arises due to computational constraints, such as memory and processing resources, and thus makes certain that the LLMs are capable of taking the input prompt as input.

The second step of the two-step approach is for the LLM 316 to generate an execution plan 310 based on the input prompt 327. The LLM 316 has a deep generative model architecture (e.g., a reversible or autoregressive architecture with) for generating the execution plan 310. In some instances, the LLM 316 has over 100 billion parameters and generates the execution plan 310 using autoregressive language modeling within a transformer architecture, allowing the LLM 316 to capture complex patterns and dependencies in the input prompt 327. The LLM's 316 ability to generate the execution plan 310 is a result of its training on diverse and extensive textual data, enabling the LLM to understand human language across a wide range of contexts. During training, the LLM 316 learns to predict the next word in a sequence given the context of the preceding words. This process involves adjusting the model's parameters (weights and biases) based on the errors between its predictions and the actual next words in the training data. When the LLM 316 receives an input such as the input prompt 327, the LLM 316 tokenizes the text into smaller units such as words or sub-words. Each token is then represented as a vector in a high-dimensional space. The LLM 316 processes the input sequence token by token, maintaining an internal representation of context. The LLM's 316 attention mechanism allows it to weigh the importance of different tokens in the context of generating the next word. For each token in the vocabulary, the LLM 316 calculates a probability distribution based on its learned parameters. This probability distribution represents the likelihood of each token being the next word given the context. To generate the execution plan 310, the LLM 316 samples a token from the calculated probability distribution. The sampled token becomes the next word in the generated sequence. This process is repeated iteratively, with each newly generated token influencing the context for generating the subsequent token. The LLM 316 can continue generating tokens until a predefined length or stopping condition is reached.

In some instances, as illustrated in FIG. 3, the LLM 316 may not be able to generate a complete execution plan 310 because it is missing information such as if more information is required to determine an appropriate agent for the response, execute one or more actions, or the like. In this particular instance, the LLM 316 has determine that in order to change the 401k contribution as request by the user, it is necessary to understand whether the user would like to change the contribution by a percentage or certain currency amount. In order to obtain this information, the LLM 316 (or another LLM such as LLM 336) generates end-user response 335 (I'm doing good. Would you like to change your contribution by percentage or amount? [Percentage][Amount]) to the input prompt 327 that can obtain the missing information such that the LLM 316 is able to generate a complete execution plan 310. In some instances, the response may be rendered within a dialogue box of a GUI having one or more GUI elements allowing for an easier response by the user. In other instances, the response may be rendered within a dialogue box of a GUI allowing for the user to reply using the dialogue box (or alternative means such as a microphone). In this particular instance, the user responds with an additional query 338 (What is my current 401k Contribution? Also, can you tell me the contribution limit?) to gather additional information such that the user can reply to the response 335. The subsequent response—additional query 338—is input into the input pipeline 308 and the same processes described above with respect to utterance 302 are executed but this time with the context of the prior utterances/replies (e.g., utterance 302 and response 335) from the user's conversation with the digital assistant. This time, as illustrated in FIG. 3, the LLM 316 is able to generate a complete execution plan 310 because it has all the information it needs.

The execution plan 310 includes an ordered list of agents and/or actions that can be used and/or executed to sufficiently respond to the request such as the additional query 338. For example, and as illustrated in FIG. 3, the execution plan 310 can be an ordered list that includes a first agent 342a capable of executing a first action 344a via an associated asset and a second agent 342b capable of executing a second action 344b via an associated asset. The agents, and by extension the actions, may be ordered to cause the first action 344a to be executed by the first agent 342a prior to causing the second action 344b to be executed by the second agent 342b. In some instances, the execution plan 310 may be ordered based on dependencies indicated by the agents and/or actions included in the execution plan 310. For example, if executing the second agent 342b is dependent on, or otherwise requires, an output generated by the first agent 342a executing the first action 344a, then the execution plan 310 may order the first agent 342a and the second agent 342b to comply with the dependency. As should be understood, other examples of dependencies are possible.

The execution plan 310 is then transmitted to an execution engine 350 for implementation. The execution engine 350 includes a number of engines, including a natural language-to-programming language translator 352, a knowledge engine 354, an API engine 356, a prompt engine 358, and the like. for executing the actions of agents and implementing the execution plan 310. For example, the natural language-to-programming language translator 352, such as a Conversation to Oracle Meaning Representation Language (C2OMRL) model, may be used by an agent to translate natural language into a intermedial logical for (e.g., OMRL), convert the intermediate logical form into a system programming language (e.g., SQL) and execute the system programming language (e.g., execute an SQL query) on an asset 319 such as data stores 323 to execute actions and/or obtain data or information. The knowledge engine 354 may be used by an agent to obtain data or information from the context and memory store 314 or an asset 319 such as files/documents 322. The API engine 356 may be used by an agent to call an API 320 and interface with an application such as retirement fund account management application to execute actions and/or obtain data or information. The prompt engine 358 may be used by an agent to construct a prompt for input into an LLM such as an LLM in the context and memory store 314 or an asset 319 to execute actions and/or obtain data or information.

The execution engine 350 implements the execution plan 310 by running each agent and executing each action in order based on the ordered list of agents and/or actions using the appropriate engine(s). To facilitate this implementation, the execution engine 350 is communicatively connected (e.g., via a public and/or provue network) with the agents (e.g., 342a, 342b, etc.), the context and memory store 314, and the assets 319. For example, as illustrated in FIG. 3, when the execution engine 350 implements the execution plan 310, it will first execute the agent 342a and action 344a using API engine 356 to call the API 320 and interface with a retirement fund account management application to retrieve the user's current 401k contribution. Subsequently, the execution engine 350 can execute the agent 342b and action 344b using knowledge engine 354 to retrieve knowledge on 401k contribution limits. In some instances, the knowledge is retrieved by knowledge engine 354 from the assets 319 (e.g., files/documents 322). In other instances (as in this particular instance), the knowledge is retrieved by knowledge engine 354 from the context and memory store 314. Knowledge retrieval and action execution using the context and memory store 314 may be implemented using various techniques including internal task mapping and/or machine learning models such as additional LLM models. For example, the query and associated agent for “What is 401k contribution limit” may be mapped to a ‘semantic search’ knowledge task type for searching the indices 313 within the context and memory store 314 for a response to a given query. By way of another example, a request such as “Can you summarize the key points relating to 401k contribution” can be or include a ‘summary’ knowledge task type that may be mapped to a different index within the context and memory store 314 having an LLM trained to create a natural language response (e.g., summary of key points relating to 401k contribution) to a given query. Over time, a library of generic end-user task or action types (e.g., semantic search, summarization, compare/contrast, heterogeneous data synthesis, etc.) may be built to ensure that the indices and models within the context and memory store 314 are optimized to the various task or action types.

The result of implementing the execution plan 310 is output data 369 (e.g., results of actions, data, information, etc.), which is transmitted to an output pipeline 370 for generating end-user responses 372. For example, the output data 369 from the assets 319 (knowledge, API, dialog history, etc.) and relevant information from the context and memory store 314 can be transmitted to the output pipeline 370. The output data 369 is appended to the utterance 302 to construct an output prompt 374 for input to the LLM 336. In some instances, context 329 concerning the utterance 302 are additionally appended to the output data 369 and the utterance 302. The context 329 is retrievable from the context and memory store 314 and includes user session information, dialog state, conversation or contextual history, user information, or any combination thereof. The LLM 336 generates responses 372 based on the output prompt 374. In some instances, the LLM 336 is the same or similar model as LLM 316. In other instances, the LLM 336 different from LLM 316 (e.g., trained on a different set of data, a different architecture, trained for a one or more different tasks, etc.). In either instance, the LLM 336 has a deep generative model architecture (e.g., a reversible or autoregressive architecture with) for generating the responses 372 using similar training and generative processes described above with respect to LLM 316. In some instances, the LLM 336 has over 100 billion parameters and generates the responses 372 using autoregressive language modeling within a transformer architecture, allowing the LLM 336 to capture complex patterns and dependencies in the output prompt 374.

In some instances, the end-user responses 372 may be in the format of a Conversation Message Model (CMM) and output as rich multi-modal responses. The CMM defines the various message types that the digital assistant can send to the user (outbound), and the user can send to the digital assistant (inbound). In certain instances, the CMM identifies the following message types:
text: Basic text message
card: A card representation that contains a title and, optionally, a description, image, and link
attachment: A message with a media URL (file, image, video, or audio)
location: A message with geo-location coordinates
postback: A message with a postback payload
   Messages that are defined in CMM are channel-agnostic and can be created using CMM syntax. The channel-specific connectors transform the CMM message into the format required by the specific channel, allowing a user to run the digital assistant on multiple channels without the need to create separate message formats for each channel.

Lastly, the output pipeline 370 transmits the responses 372 to the end user such as via a user device or interface. In some instances, the responses 372 are rendered within a dialogue box of a GUI allowing for the user to view and reply using the dialogue box (or alternative means such as a microphone). In other instances, the responses 372 are rendered within a dialogue box of a GUI having one or more GUI elements allowing for an easier response by the user. In this particular instance, a first response 372 (What is my current 401k Contribution? Also, can you tell me the contribution limit?) to the additional query 338 is rendered within the dialogue box of a GUI. Additionally, in order to follow-up on obtaining information still required for the initial utterance 302, the LLM 336 generates another response 372 prompting the user for the missing information (Would you like to change your contribution by percentage or amount?[Percentage][Amount]).

While the embodiment of computing environment 300 in FIG. 3 illustrates the digital assistant interacting in a particular conversation flow, this is not intended to be limiting and is merely provided to facilitate a better understanding of the role and responsibility of the components, services, models, and the like of the computing environment 300 within the conversation flow.

Flowcharts of Processes Involving a Digital Assistant that can be Implemented with Generative Artificial Intelligence

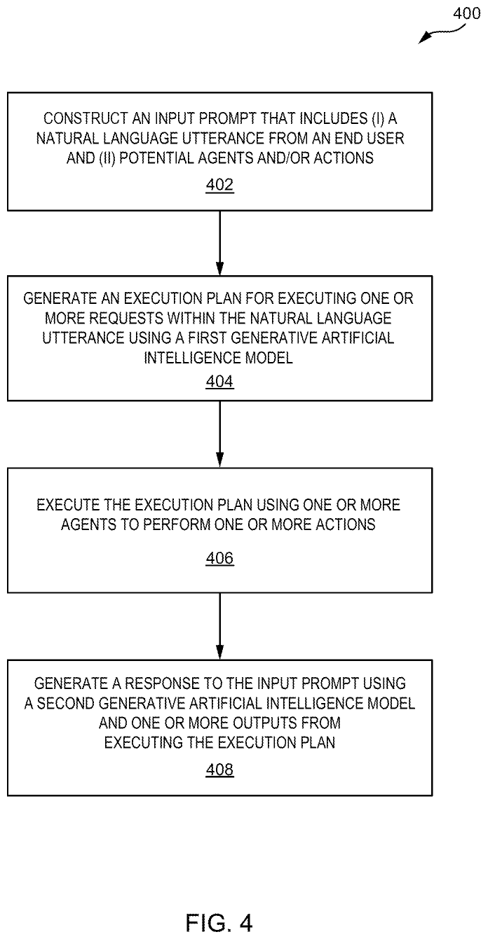

FIG. 4 is a flowchart of a process 400 for generating a response to user input using a digital assistant that can be implemented using generative artificial intelligence in according with various embodiments. The processing depicted in FIG. 4 may be implemented in software (e.g., code, instructions, program) executed by one or more processing units (e.g., processors, cores) of the respective systems, hardware, or combinations thereof. The software may be stored on a non-transitory storage medium (e.g., on a memory device). The process presented in FIG. 4 and described below is intended to be illustrative and non-limiting. Although FIG. 4 illustrates the various processing steps occurring in a particular sequence or order, this is not intended to be limiting. In certain alternative embodiments, the steps may be performed in some different order or some steps may also be performed in parallel. In certain embodiments, the processing depicted in FIG. 4 may be performed by one or more of the components, computing devices, services, or the like, such as the digital assistant, the first and/or second generative artificial intelligence model (LLMs), etc., illustrated and described with respect to FIGS. 1-3.

At 402, an input prompt is constructed based on a natural language utterance received from a user of a digital assistant. The input prompt may be constructed by a digital assistant for input into a first generative artificial intelligence model (e.g., LLM).

In some instances, the input prompt is constructed based on the natural language utterance received from a user of the digital assistant and one or more candidate agents and associated actions identified from a data store of available agents and actions.

In some instances, constructing the input prompt comprises executing, using the natural language utterance, a sematic search on descriptions associated with the available agents and actions in the data store, identifying, based on the semantic search, the one or more potential agents and associated actions, and constructing a natural language representation for the input prompt by appending one or more potential agents and associated actions to the natural language utterance.

In some instances, the natural language utterance is a continuation or subsequent utterance within a conversation, and the input prompt further comprises: (iii) conversation history and actions executed prior to the natural language utterance. In some instances, constructing the input prompt comprises accessing the conversation history and the actions executed prior to the natural language utterance, and constructing the natural language representation for the input prompt by appending the one or more potential agents, the associated actions, and the conversation history and the actions executed prior to the natural language utterance to the natural language utterance.

In some instances, the one or more agents are a plurality of agents and the one or more actions are a plurality of actions. A first subset of the plurality of agents and the plurality of actions may be in a first state and a second subset of the plurality of agents and the plurality of actions may be in a second state. The first state is a ready for execution state and the second state is not ready for execution state where additional information is required prior to execution of one or more actions within the second subset of the plurality of agents and the plurality of actions.

At 404, an execution plan is generated for executing one or more requests represented by the natural language utterance. The execution plan is generated by a first generative artificial intelligence model using the input prompt from 402.

In some instances, generating the execution plan comprises determining, based on the one or more potential agents and associated actions, one or more agents and one or more actions associated with the one or more agents that can service the one or more requests, and generating a structured output for the execution plan by creating an ordered list that comprises one or more actions (and optionally the one or more agents associated with the actions) for executing the one or more requests.

At 406, the execution plan is executed to perform the one or more actions using one or more agents. In some instances, executing the execution plan comprises triggering performance of the one or more actions by the one or more agents, and receiving one or more outputs from performance of the one or more actions by the one or more agents.

In some instances, executing the execution plan further comprises accessing contextual information that is needed by at least one of the one or more agents for performing at least one of the one or more actions, and triggering the performance of the one or more actions comprises forwarding one or more requests for performance of the one or more actions to the one the one or more agents. A request of the one or more requests being forwarded for performance of the at least one of the one or more actions may include the contextual information.

At 408, a response to the natural language utterance is generated by a second generative artificial intelligence model using the one or more outputs. The second generative artificial intelligence model may be similar or identical to, or may be different than, the first generative artificial intelligence model.

In some instances, the one or more agents are a plurality of agents, the one or more actions are a plurality of actions, and the one or more requests are a plurality of requests, and generating the execution plan further comprises determining whether one or more dependencies exist between the plurality of actions, and when the one or more dependencies exist, the ordered list is created to comprise the plurality agents, the plurality of actions for executing the one or more requests, and an indication of the one or more dependencies, when the execution plan comprises the indication of the one or more dependencies, the performance of the one or more actions by the one or more agents is triggered via serial processing, when the execution plan does not comprise the indication of the one or more dependencies, the performance of the one or more actions by the one or more agents is triggered via parallel processing, and the response is an aggregate response comprising a plurality of responses to the plurality of requests within the natural language utterance.

In some instances, the natural language utterance is a continuation or subsequent utterance within a conversation, and the response to the natural language utterance is generated by the second generative artificial intelligence model using the one or more output, the natural language utterance, and a conversation history for the conversation.

In some instances, the response is communicated to the user.

### Illustrative Systems

FIG. 5 depicts a simplified diagram of a distributed system 500. In the illustrated example, distributed system 500 includes one or more client computing devices 502, 504, 506, and 508, coupled to a server 512 via one or more communication networks 510. Clients computing devices 502, 504, 506, and 508 may be configured to execute one or more applications.

In various examples, server 512 may be adapted to run one or more services or software applications that enable one or more embodiments described in this disclosure. In certain examples, server 512 may also provide other services or software applications that may include non-virtual and virtual environments. In some examples, these services may be offered as web-based or cloud services, such as under a Software as a Service (SaaS) model to the users of client computing devices 502, 504, 506, and/or 508. Users operating client computing devices 502, 504, 506, and/or 508 may in turn utilize one or more client applications to interact with server 512 to utilize the services provided by these components.

In the configuration depicted in FIG. 5, server 512 may include one or more components 518, 520 and 522 that implement the functions performed by server 512. These components may include software components that may be executed by one or more processors, hardware components, or combinations thereof. It should be appreciated that various different system configurations are possible, which may be different from distributed system 500. The example shown in FIG. 5 is thus one example of a distributed system for implementing an example system and is not intended to be limiting.

Users may use client computing devices 502, 504, 506, and/or 508 to execute one or more applications, models or chatbots, which may generate one or more events or models that may then be implemented or serviced in accordance with the teachings of this disclosure. A client device may provide an interface that enables a user of the client device to interact with the client device. The client device may also output information to the user via this interface. Although FIG. 5 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 510 may be any type of network familiar to those skilled in the art that may support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 510 may be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 512 may include one or more virtual machines running virtual operating systems, or other computing architectures involving virtualization such as one or more flexible pools of logical storage devices that may be virtualized to maintain virtual storage devices for the server. In various examples, server 512 may be adapted to run one or more services or software applications that provide the functionality described in the foregoing disclosure.

The computing systems in server 512 may run one or more operating systems including any of those discussed above, as well as any commercially available server operating system. Server 512 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 512 may include one or more applications to analyze and consolidate data feeds and/or event updates received from users of client computing devices 502, 504, 506, and 508. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 512 may also include one or more applications to display the data feeds and/or real-time events via one or more display devices of client computing devices 502, 504, 506, and 508.

Distributed system 500 may also include one or more data repositories 514, 516. These data repositories may be used to store data and other information in certain examples. For example, one or more of the data repositories 514, 516 may be used to store information such as information related to chatbot performance or generated models for use by chatbots used by server 512 when performing various functions in accordance with various embodiments. Data repositories 514, 516 may reside in a variety of locations. For example, a data repository used by server 512 may be local to server 512 or may be remote from server 512 and in communication with server 512 via a network-based or dedicated connection. Data repositories 514, 516 may be of different types. In certain examples, a data repository used by server 512 may be a database, for example, a relational database, such as databases provided by Oracle Corporation® and other vendors. One or more of these databases may be adapted to enable storage, update, and retrieval of data to and from the database in response to SQL-formatted commands.

In certain examples, one or more of data repositories 514, 516 may also be used by applications to store application data. The data repositories used by applications may be of different types such as, for example, a key-value store repository, an object store repository, or a general storage repository supported by a file system.

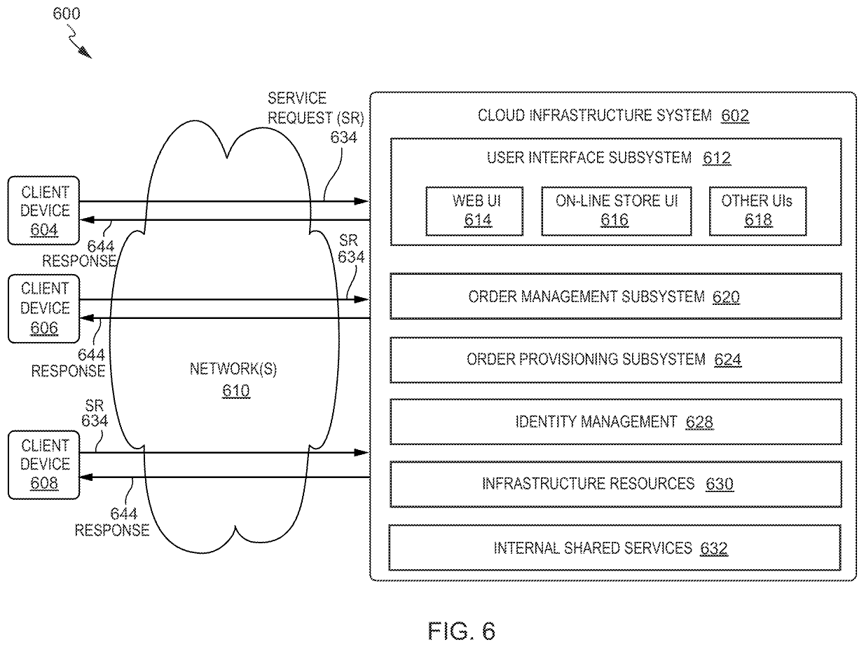

In certain examples, the functionalities described in this disclosure may be offered as services via a cloud environment. FIG. 6 is a simplified block diagram of a cloud-based system environment in which various services may be offered as cloud services in accordance with certain examples. In the example depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The example depicted in FIG. 6 is only one example of a cloud infrastructure system and is not intended to be limiting. It should be appreciated that, in some other examples, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative examples.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the customer's own on-premise servers and systems. The cloud service provider's systems are managed by the cloud service provider. Customers may thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, California, such as middleware services, database services, Java cloud services, and others.

In certain examples, cloud infrastructure system 602 may provide one or more cloud services using different models such as under a Software as a Service (SaaS) model, a Platform as a Service (PaaS) model, an Infrastructure as a Service (IaaS) model, and others, including hybrid service models. Cloud infrastructure system 602 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 602. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 602. Cloud infrastructure system 602 then performs processing to provide the services requested in the customer's subscription order. For example, a user may use utterances to request the cloud infrastructure system to take a certain action (e.g., an intent), as described above, and/or provide services for a chatbot system as described herein. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public customer, where the customer may be an individual or an enterprise. In certain other examples, under a private cloud model, cloud infrastructure system 602 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other examples, under a community cloud model, the cloud infrastructure system 602 and the services provided may be shared by several organizations in a related community. Various other models such as hybrids of the above mentioned models may also be used.

Client computing devices 604, 606, and 608 may be of different types (such as client computing devices 502, 504, 506, and 508 depicted in FIG. 5) and may be capable of operating one or more client applications. A user may use a client device to interact with cloud infrastructure system 602, such as to request a service provided by cloud infrastructure system 602. For example, a user may use a client device to request information or action from a chatbot as described in this disclosure.

In some examples, the processing performed by cloud infrastructure system 602 for providing services may involve model training and deployment. This analysis may involve using, analyzing, and manipulating data sets to train and deploy one or more models. This analysis may be performed by one or more processors, possibly processing the data in parallel, performing simulations using the data, and the like. For example, big data analysis may be performed by cloud infrastructure system 602 for generating and training one or more models for a chatbot system. The data used for this analysis may include structured data (e.g., data stored in a database or structured according to a structured model) and/or unstructured data (e.g., data blobs (binary large objects)).

As depicted in the example in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like. In certain examples, the storage virtual machines that are available for servicing storage requested from applications may be part of cloud infrastructure system 602. In other examples, the storage virtual machines may be part of different systems.

In certain examples, to facilitate efficient provisioning of these resources for supporting the various cloud services provided by cloud infrastructure system 602 for different customers, the resources may be bundled into sets of resources or resource modules (also referred to as “pods”). Each resource module or pod may comprise a pre-integrated and optimized combination of resources of one or more types. In certain examples, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users or customers of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a customer may, using a client device, request (service request 634) one or more services provided by cloud infrastructure system 602 using one or more of interfaces 614, 616, and 618. For example, a customer may access the online store, browse cloud services offered by cloud infrastructure system 602, and place a subscription order for one or more services offered by cloud infrastructure system 602 that the customer wishes to subscribe to. The service request may include information identifying the customer and one or more services that the customer desires to subscribe to. For example, a customer may place a subscription order for a service offered by cloud infrastructure system 602. As part of the order, the customer may provide information identifying a chatbot system for which the service is to be provided and optionally one or more credentials for the chatbot system.

In certain examples, such as the example depicted in FIG. 6, cloud infrastructure system 602 may comprise an order management subsystem (OMS) 620 that is configured to process the new order. As part of this processing, OMS 620 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

In certain examples, setup phase processing, as described above, may be performed by cloud infrastructure system 602 as part of the provisioning process. Cloud infrastructure system 602 may generate an application ID and select a storage virtual machine for an application from among storage virtual machines provided by cloud infrastructure system 602 itself or from storage virtual machines provided by other systems other than cloud infrastructure system 602.

Cloud infrastructure system 602 may send a response or notification 644 to the requesting customer to indicate when the requested service is now ready for use. In some instances, information (e.g., a link) may be sent to the customer that enables the customer to start using and availing the benefits of the requested services. In certain examples, for a customer requesting the service, the response may include a chatbot system ID generated by cloud infrastructure system 602 and information identifying a chatbot system selected by cloud infrastructure system 602 for the chatbot system corresponding to the chatbot system ID.

Cloud infrastructure system 602 may provide services to multiple customers. For each customer, cloud infrastructure system 602 is responsible for managing information related to one or more subscription orders received from the customer, maintaining customer data related to the orders, and providing the requested services to the customer. Cloud infrastructure system 602 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 602 may provide services to multiple customers in parallel. Cloud infrastructure system 602 may store information for these customers, including possibly proprietary information. In certain examples, cloud infrastructure system 602 comprises an identity management subsystem (IMS) 628 that is configured to manage customer information and provide the separation of the managed information such that information related to one customer is not accessible by another customer. IMS 628 may be configured to provide various security-related services such as identity services, such as information access management, authentication and authorization services, services for managing customer identities and roles and related capabilities, and the like.

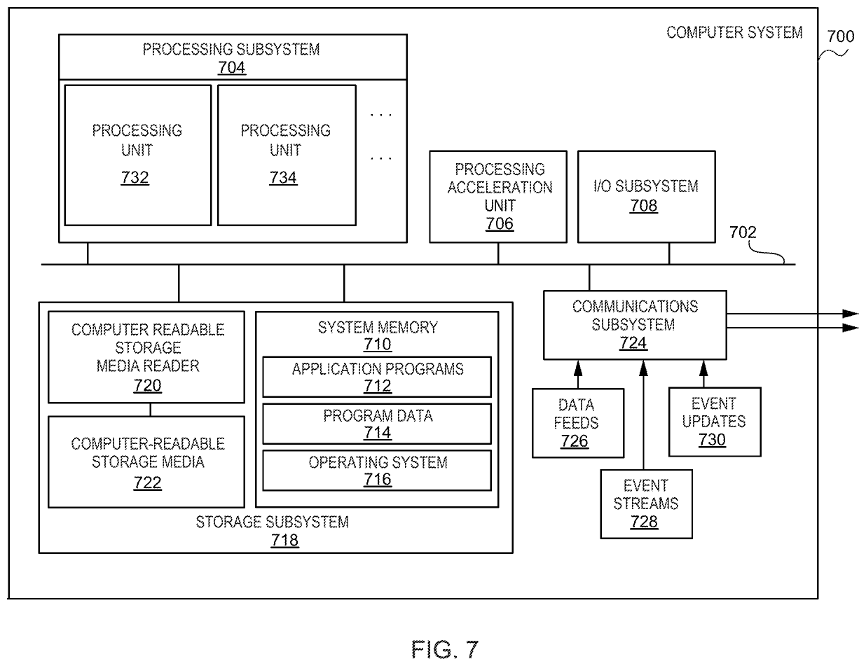

FIG. 7 illustrates an example of computer system 700. In some examples, computer system 700 may be used to implement any of the digital assistant or chatbot systems within a distributed environment, and various servers and computer systems described above. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including computer-readable storage media 722 and a system memory 710.

Bus subsystem 702 provides a mechanism for letting the various components and subsystems of computer system 700 communicate with each other as intended. Although bus subsystem 702 is shown schematically as a single bus, alternative examples of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which may be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may include be single core or multicore processors. The processing resources of computer system 700 may be organized into one or more processing units 732, 734, etc. A processing unit may include one or more processors, one or more cores from the same or different processors, a combination of cores and processors, or other combinations of cores and processors. In some examples, processing subsystem 704 may include one or more special purpose co-processors such as graphics processors, digital signal processors (DSPs), or the like. In some examples, some or all of the processing units of processing subsystem 704 may be implemented using customized circuits, such as application specific integrated circuits (ASICs), or field programmable gate arrays (FPGAs).

In some examples, the processing units in processing subsystem 704 may execute instructions stored in system memory 710 or on computer-readable storage media 722. In various examples, the processing units may execute a variety of programs or code instructions and may maintain multiple concurrently executing programs or processes. At any given time, some or all of the program code to be executed may be resident in system memory 710 and/or on computer-readable storage media 722 including potentially on one or more storage devices. Through suitable programming, processing subsystem 704 may provide various functionalities described above. In instances where computer system 700 is executing one or more virtual machines, one or more processing units may be allocated to each virtual machine.

In certain examples, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect© motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google Glass®). Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some examples. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide authentication in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 722 may store programming and data constructs that provide the functionality of some examples. Computer-readable storage media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, DVD, a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain examples, storage subsystem 718 may also include a computer-readable storage media reader 720 that may further be connected to computer-readable storage media 722. The computer-readable storage media reader 720 may receive and be configured to read data from a memory device such as a disk, a flash drive, etc.

In certain examples, computer system 700 may support virtualization technologies, including but not limited to virtualization of processing and memory resources. For example, computer system 700 may provide support for executing one or more virtual machines. In certain examples, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, when computer system 700 is used to implement digital assistant 106 depicted in FIG. 1, the communication subsystem may be used to communicate with a chatbot system selected for an application.

Communication subsystem 724 may support both wired and/or wireless communication protocols. In certain examples, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some examples, communications subsystem 724 may provide wired network connectivity (e.g., Ethernet) in addition to or instead of a wireless interface.

Communication subsystem 724 may receive and transmit data in various forms. In some examples, in addition to other forms, communications subsystem 724 may receive input communications in the form of structured and/or unstructured data feeds 726, event streams 728, event updates 730, and the like. For example, communications subsystem 724 may be configured to receive (or send) unstructured data feeds 726 in real-time from users of social media networks and/or other communication services such as Twitter® feeds, Facebook® updates, web feeds such as Rich Site Summary (RSS) feeds, and/or real-time updates from one or more third party information sources.

In certain examples, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 may be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, it should be appreciate there are other ways and/or methods to implement the various examples.

Although specific examples have been described, various modifications, alterations, alternative constructions, and equivalents are possible. Examples are not restricted to operation within certain specific data processing environments, but are free to operate within a plurality of data processing environments. Additionally, although certain examples have been described using a particular series of transactions and steps, it should be apparent to those skilled in the art that this is not intended to be limiting. Although some flowcharts describe operations as a sequential process, many of the operations may be performed in parallel or concurrently. In addition, the order of the operations may be rearranged. A process may have additional steps not included in the figure. Various features and aspects of the above-described examples may be used individually or jointly.

Further, while certain examples have been described using a particular combination of hardware and software, it should be recognized that other combinations of hardware and software are also possible. Certain examples may be implemented only in hardware, or only in software, or using combinations thereof. The various processes described herein may be implemented on the same processor or different processors in any combination.

Where devices, systems, subsystems, components or services are described as being configured to perform certain operations or functions, such configuration may be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes may communicate using a variety of techniques including but not limited to conventional techniques for inter-process communications, and different pairs of processes may use different techniques, or the same pair of processes may use different techniques at different times.

Specific details are given in this disclosure to provide a thorough understanding of the examples. However, examples may be practiced without these specific details. For example, well-known circuits, processes, algorithms, structures, and techniques have been shown without unnecessary detail in order to avoid obscuring the examples. This description provides example examples only, and is not intended to limit the scope, applicability, or configuration of other examples. Rather, the preceding description of the examples will provide those skilled in the art with an enabling description for implementing various examples. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific examples have been described, these are not intended to be limiting. Various modifications and equivalents are within the scope of the following claims.

In the foregoing specification, aspects of the disclosure are described with reference to specific examples thereof, but those skilled in the art will recognize that the disclosure is not limited thereto. Various features and aspects of the above-described disclosure may be used individually or jointly. Further, examples may be utilized in any number of environments and applications beyond those described herein without departing from the broader spirit and scope of the specification. The specification and drawings are, accordingly, to be regarded as illustrative rather than restrictive.

In the foregoing description, for the purposes of illustration, methods were described in a particular order. It should be appreciated that in alternate examples, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Where components are described as being configured to perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

While illustrative examples of the application have been described in detail herein, it is to be understood that the inventive concepts may be otherwise variously embodied and employed, and that the appended claims are intended to be construed to include such variations, except as limited by the prior art.

What is claimed is:

1. A computer-implemented method comprising:
constructing an input prompt comprising a natural language utterance received from a user;
generating, by a first generative artificial intelligence model using the input prompt, an execution plan for executing one or more requests represented by the natural language utterance, wherein generating the execution plan comprises:
determining, based on the one or more potential agents and associated actions, one or more agents and one or more actions associated with the one or more agents that can service the one or more requests, and
generating a structured output for the execution plan by creating an ordered list that comprises one or more actions for executing the one or more requests;
executing the execution plan to perform the one or more actions using one or more agents, wherein executing the execution plan comprises:
triggering performance of the one or more actions by the one or more agents, and
receiving one or more outputs from performance of the one or more actions by the one or more agents; and
generating, by a second generative artificial intelligence model using the one or more outputs, a response to the natural language utterance.

2. The computer-implemented method of claim 1, wherein constructing the input prompt comprises:
executing, using the natural language utterance, a semantic search on descriptions associated with the available agents and actions in a data store;
identifying, based on a semantic search, the one or more candidate agents and associated actions; and
constructing a natural language representation for the input prompt by appending the one or more candidate agents and associated actions to the natural language utterance.

3. The computer-implemented method of claim 2, wherein:
the natural language utterance is a continuation or subsequent utterance within a conversation,
the input prompt further comprises: (iii) conversation history and actions executed prior to the natural language utterance, and
constructing the input prompt comprises accessing the conversation history and the actions executed prior to the natural language utterance, and constructing the natural language representation for the input prompt by appending the one or more candidate agents, the associated actions, and the conversation history and the actions executed prior to the natural language utterance to the natural language utterance.

4. The computer-implemented method of claim 3, wherein:
the one or more agents are a plurality of agents and the one or more actions are a plurality of actions,
a first subset of the plurality of agents and the plurality of actions are in a first state and a second subset of the plurality of agents and the plurality of actions are in a second state,
the first state is a ready-for-execution state, and
the second state is a not-ready-for-execution state where additional information is required prior to execution of one or more actions within the second subset of the plurality of agents and the plurality of actions.

5. The computer-implemented method of claim 1, wherein:
executing the execution plan further comprises accessing contextual information that is needed by at least one of the one or more agents for performing at least one of the one or more actions;
triggering the performance of the one or more actions comprises forwarding one or more requests for performance of the one or more actions to the one the one or more agents; and
a request of the one or more requests being forwarded for performance of the at least one of the one or more actions includes the contextual information.

6. The computer-implemented method of claim 1, wherein:
the one or more agents are a plurality of agents, the one or more actions are a plurality of actions, and the one or more requests are a plurality of requests,
generating the execution plan further comprises determining whether one or more dependencies exist between the plurality of actions, and when the one or more dependencies exist, the ordered list is created to comprise the plurality of agents, the plurality of actions for executing the one or more requests, and an indication of the one or more dependencies,
when the execution plan comprises the indication of the one or more dependencies, the performance of the one or more actions by the one or more agents is triggered via serial processing,
when the execution plan does not comprise the indication of the one or more dependencies, the performance of the one or more actions by the one or more agents is triggered via parallel processing, and
the response is an aggregate response comprising a plurality of responses to the plurality of requests within the natural language utterance.

7. The computer-implemented method of claim 1, wherein:
the natural language utterance is a continuation or subsequent utterance within a conversation, and
the response to the natural language utterance is generated by the second generative artificial intelligence model using the one or more outputs, the natural language utterance, and a conversation history for the conversation.

8. The computer-implemented method of claim 1, further comprising communicating the response to the user.

9. The computer-implemented method of claim 1, wherein the first generative artificial intelligence model is the same model as the second generative artificial intelligence model.

10. A system comprising:
one or more processors; and
one or more computer-readable media storing instructions which, when executed by the one or more processors, cause the system to perform operations comprising:
constructing an input prompt comprising a natural language utterance received from a user;
generating, by a first generative artificial intelligence model using the input prompt, an execution plan for executing one or more requests represented by the natural language utterance, wherein generating the execution plan comprises:
determining, based on the one or more potential agents and associated actions, one or more agents and one or more actions associated with the one or more agents that can service the one or more requests, and
generating a structured output for the execution plan by creating an ordered list that comprises one or more actions for executing the one or more requests;
executing the execution plan to perform the one or more actions using one or more agents, wherein executing the execution plan comprises:
triggering performance of the one or more actions by the one or more agents, and
receiving one or more outputs from performance of the one or more actions by the one or more agents; and
generating, by a second generative artificial intelligence model using the one or more outputs, a response to the natural language utterance.

11. The system of claim 10, wherein the operation of constructing the input prompt comprises:
executing, using the natural language utterance, a sematic search on descriptions associated with the available agents and actions in a data store;
identifying, based on a semantic search, the one or more candidate agents and associated actions; and
constructing a natural language representation for the input prompt by appending one or more candidate agents and associated actions to the natural language utterance.

12. The system of claim 11, wherein:
the natural language utterance is a continuation or subsequent utterance within a conversation,
the input prompt further comprises: (iii) conversation history and actions executed prior to the natural language utterance, and
the operation of constructing the input prompt comprises accessing the conversation history and the actions executed prior to the natural language utterance, and constructing the natural language representation for the input prompt by appending the one or more candidate agents, the associated actions, and the conversation history and the actions executable prior to the natural language utterance to the natural language utterance.

13. The system of claim 12, wherein:
the one or more agents are a plurality of agents and the one or more actions are a plurality of actions,
a first subset of the plurality of agents and the plurality of actions are in a first state and a second subset of the plurality of agents and the plurality of actions are in a second state,
the first state is a ready-for-execution state, and
the second state is a not-ready-for-execution state where additional information is required prior to execution of one or more actions within the second subset of the plurality of agents and the plurality of actions.

14. The system of claim 10, wherein:
the operation of executing the execution plan comprises accessing contextual information that is needed by at least one of the one or more agents for performing at least one of the one or more actions;
the operation of triggering the performance of the one or more actions comprises forwarding one or more requests for performance of the one or more actions to the one the one or more agents; and
a request of the one or more requests being forwarded for performance of the at least one of the one or more actions includes the contextual information.

15. The system of claim 10, wherein:
the one or more agents are a plurality of agents, the one or more actions are a plurality of actions, and the one or more requests are a plurality of requests,
the operation of generating the execution plan further comprises determining whether one or more dependencies exist between the plurality of actions, and when the one or more dependencies exist, the ordered list is created to comprise the plurality of agents, the plurality of actions for executing the one or more requests, and an indication of the one or more dependencies,
when the execution plan comprises the indication of the one or more dependencies, the performance of the one or more actions by the one or more agents is triggered via serial processing,
when the execution plan does not comprise the indication of the one or more dependencies, the performance of the one or more actions by the one or more agents is triggered via parallel processing, and
the response is an aggregate response comprising a plurality of responses to the plurality of requests within the natural language utterance.

16. One or more non-transitory computer-readable media storing instructions which, when executed by one or more processors, cause a system to perform operations comprising:
constructing an input prompt comprising: (i) a natural language utterance received from a user and (ii) one or more candidate agents and associated actions identified from a data store of available agents and actions;
generating, by a first generative artificial intelligence model using the input prompt, an execution plan for executing one or more requests within the natural language utterance, wherein generating the execution plan comprises:
determining, based on the one or more candidate agents and associated actions, one or more agents and one or more actions associated with the one or more agents that can service the one or more requests, and
generating a structured output for the execution plan by creating an ordered list comprising the one or more agents and one or more actions for executing the one or more requests;
executing the execution plan to perform the one or more actions using the one or more agents, wherein executing the execution plan comprises:
triggering performance of the one or more actions by the one or more agents, and
receiving one or more outputs from performance of the one or more actions by the one or more agents; and
generating, by a second generative artificial intelligence model using the one or more outputs, a response to the natural language utterance.

17. The one or more non-transitory computer-readable media of claim 16, wherein the operation of constructing the input prompt comprises:
executing, using the natural language utterance, a sematic search on descriptions associated with the available agents and actions in the data store;
identifying, based on a semantic search, the one or more candidate agents and associated actions; and
constructing a natural language representation for the input prompt by appending one or more candidate agents and associated actions to the natural language utterance.

18. The one or more non-transitory computer-readable media of claim 16, wherein:
the natural language utterance is a continuation or subsequent utterance within a conversation, and
the response to the natural language utterance is generatable by the second generative artificial intelligence model using the one or more outputs, the natural language utterance, and a conversation history for the conversation.

19. The one or more non-transitory computer-readable media of claim 16, wherein the operations further comprise communicating the response to the user.

20. The one or more non-transitory computer-readable media of claim 16, wherein the first generative artificial intelligence model is the same model as the second generative artificial intelligence model.
